(19) United States
(12) Patent Application Publication
(10) Pub. No.: US 2004/0046386 A1
(43) Pub. Date: Mar. 11, 2004

(54) Joint device in a pipeline

(76) Inventors: Alex Chien, Taipei (TW); Chun-Pao Chiang, Taipei Hsien (TW)

Correspondence Address: Connolly Bove Lodge & Hutz, LLP, P.O. Box 2207, Wilmington, DE, 19899-2207, US

(21) Appl. No.: 10/288,175

(22) Filed: Nov. 5, 2002

(30) Foreign Application Priority Data
Sep. 10, 2002 (TW) 091214193

(51) Int. Cl. F16L 43/00

(52) U.S. Cl. 285/276; 285/305; 285/179

(57) ABSTRACT

A joint device in a pipeline includes a connecting body, a joining screw nut, a connecting joint and two fixing coils. The connecting body has a connecting pipe with an end thereof being a connector and another end thereof being another connector. The first connector is provided with an annular recess and the second connector has at least two annular recesses. The joining screw nut at an end thereof is provided with internal threads and at another end thereof has a radial hole and is used for engaging with the first connector. The connecting joint at an end thereof has a radial hole corresponding to one of the annular recess on the second connector and extends outward a screw rod portion with a conical end. One of fixing coils is inserted into the annular recess on the first connector via the radial hole of the joining screw nut and the other fixing coil is inserted into one of the annular recesses on the second connector via the radial hole of the connecting joint. Hence, the pipeline can be connected and direction-adjusted easily in spite of the space limitation.

### BACKGROUND OF THE INVENTION

1. Field of the Invention

The present invention relates to a joint device in a pipeline and in particular to an improved structure with regard to a joint in a pipeline.

2. Description of Related Art

The conventional equipment such as an automobile engine, an oil pumping machine and so on usually have mounted with oil pipes, which include flexible hoses and metal pipes connecting with each other. While the flexible hoses connecting with the metal pipes by way of connecting ends of the metal pipes fitting with the hoses is easily performed, it is liable to loosen and fall apart. Although a connecting joint is used for securing the connection between a metal pipe and a flexible hose, the connecting joint has a complicate structure to result in extremely inconvenient connection job. Especially, when two metal pipes are connected to each other, it may cause connection problem in case of the two pipes being not aligned with each other.

### SUMMARY OF THE INVENTION

The crux of the present invention is in that a joint device in a pipeline includes a connecting body, a joining screw nut, a connecting joint and two fixing coils. The connecting body has a connecting pipe with an end thereof being a connector and another end thereof being another connector. The first connector is provided with an annular recess and the second connector has at least two annular recesses. The joining screw nut at an end thereof is provided with internal threads and at another end thereof has a radial hole and is used for engaging with the first connector. The connecting joint at an end thereof has a radial hole corresponding to one of the annular recess on the second connector and extends outward a screw rod portion with a conical end. One of fixing coils is inserted into the annular recess on the first connector via the radial hole of the joining screw nut and the other fixing coil is inserted into one of the annular recesses on the second connector via the radial hole of the connecting joint. Hence, the pipeline can be connected and direction-adjusted easily in spite of the space limitation.

Accordingly, a main object of the present invention is to provide a joint device in pipeline, which has fixing coil inserted therein so that the joint device is able to connect with the pipelines with facility even if only a limited space is available.

Another object of the present invention to provide a joint device in a pipeline, in which the connecting pipe of the connecting body can be a metal flexible pipe, so that it is possible to obtain advantages such as shockproof and being easily bent for performing connecting job.

### BRIEF DESCRIPTION OF DRAWINGS

FIG. 1 is a perspective view of a joint device in a pipeline according to the present invention.

FIG. 2 is an exploded perspective view of the joint device shown in FIG. 1.

FIG. 3 is a sectional view of the joint device shown in FIG. 1.

FIG. 4 is a perspective view of another embodiment of the joint device of the present invention.

### DETAILED DESCRIPTION OF THE PREFERRED EMBODIMENT

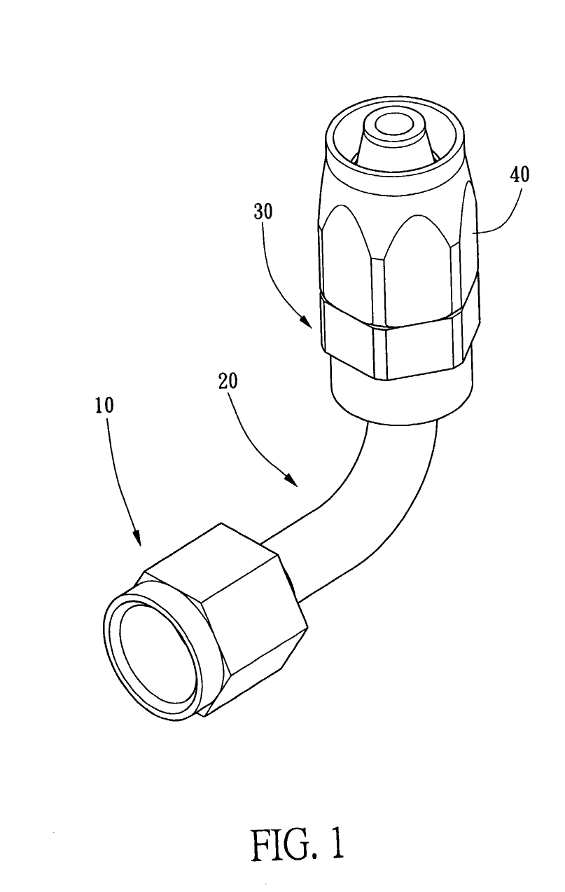

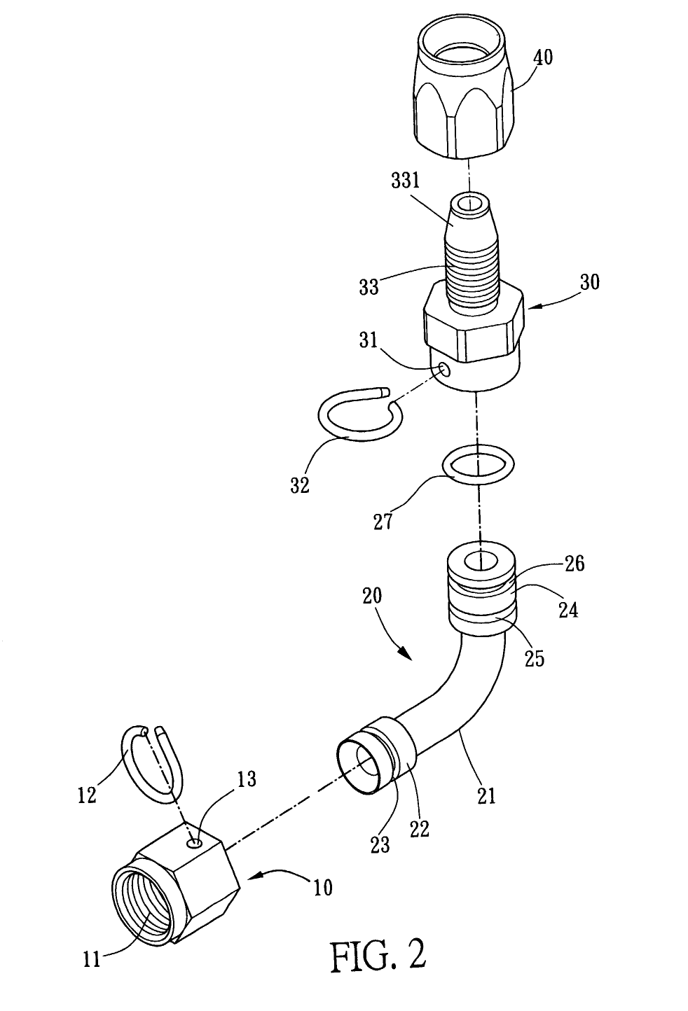

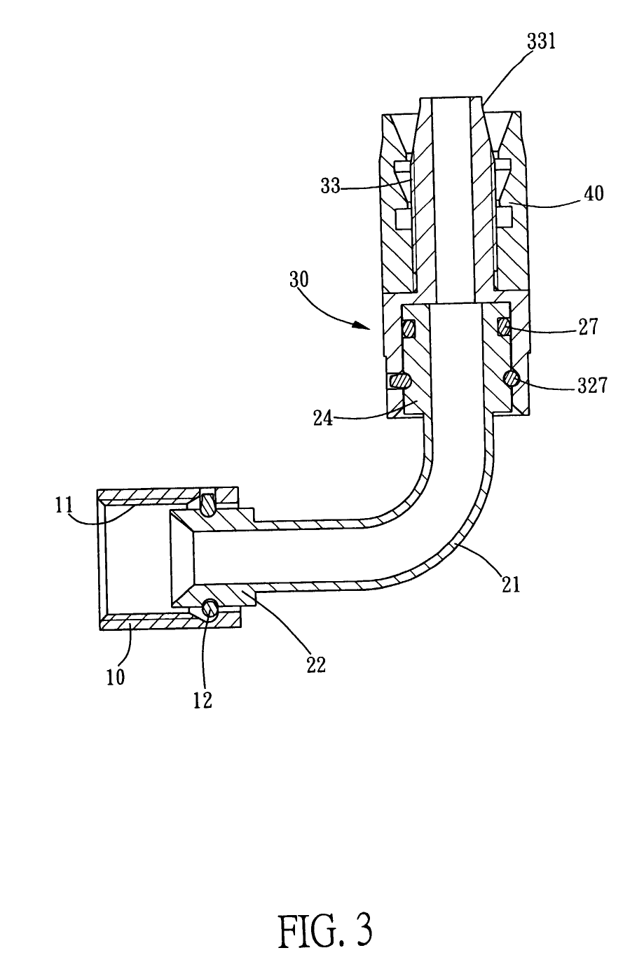

Firstly, please referring to FIGS. 1, 2 and 3, a joint device in a pipeline of the present invention includes a joining screw nut 10, a connecting body 20, a joint 30 and an engaging screw cap 40.

The joining screw nut 10 at an end thereof is provided with internal threads 11 and at another end thereof has a radial hole 13 for being passed though with a fixing coil 12 so that the fixing coil 12 can be fixedly attached to the connecting body 20.

The connecting body 20 basically has a connecting pipe 21 with an end thereof being a connector 22 and another end thereof being a connector 24. The connector 22 is provided with an annular recess 23 corresponding to the radial hole 13 and the connector 24 has at least two annular recesses 25, 26 for fitting with an “O” ring 27 and a fixing coil 32.

The connecting joint 30 at an end thereof has a radial hole 31 corresponding to the annular recess 23 on the joint 24 for being passed through by the fixing coil 32 and toward the other end thereof extends a screw rod portion 33 with a conical end edge 331.

The engaging screw cap 40 provides internal threads for being fastened to the connecting joint 30.

In practice, the joining screw nut 10 is engaged to a pipeline to be connected and the fixing coil 12 is inserted into the annular recess 23 on the joining body 20 via the radial hole 13 of the joining screw nut 10 so that the joining screw nut 10 can be connected to the pipeline. Then, the fixing coil 32 is inserted into the annular recess 25 on the joining body 20 via the radial hole 31 of the connecting joint 30 so that the connector 24 can be connected to another pipeline. With the connecting joint of the present invention, the pipeline can be connected and direction-adjusted easily in spite of the space limitation.

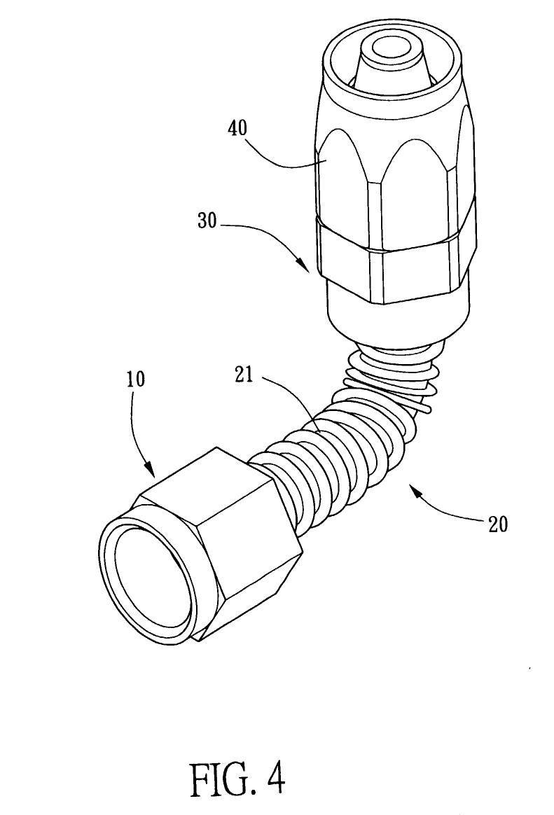

Next, referring to FIG. 4, another preferred embodiment of the present invention is illustrated. It can be seen that the connecting pipe 21 of the connecting body 20 is a metal flexible pipe instead. The flexible connecting pipe 21 has advantages of shockproof and being bent easily for fabrication.

It is appreciated that the connecting joint disclosed in the present invention provides fixing coils being inserted into annular recesses arranged at the screw nut and the screw cap at both ends of the connecting body via radial holes to ease the pipeline connection and direction adjustment even if the available space for mounting the pipeline is very limited.

While the present invention herein disclosed has been described by means of specific embodiments and applications thereof, numerous modifications and variations could be made thereto by those skilled in the art without departing from the scope of the present invention set forth in the claims.

What is claimed is:

1. A joint device in a pipeline, comprising:
a connecting body, having a connecting pipe with an end thereof being a first connector and another end thereof being a second connector, the first connector being provided with an annular recess and the second connector having at least two annular recesses;
a joining screw nut, an end thereof being provided with internal threads and another end thereof having a radial hole and engaging with the first connector;
a connecting joint, an end thereof having a radial hole corresponding to one of the annular recess on the second connector, extending outward a screw rod portion with a conical end; and
two fixing coils, one of fixing coils being inserted into the annular recess on the first connector via the radial hole of the joining screw nut and the other one of the fixing coils being inserted into one of the annular recesses on the second connector via the radial hole of the connecting joint.

2. The joint device in a pipeline as recited in claim 1, wherein the connecting pipe of said connecting body is a metal flexible pipe.

3. The joint device in a pipeline as recited in claim 1, wherein another one of the annular recesses on the second connector fits with an “O” ring.
